(19) United States
(12) Patent Application Publication
(10) Pub. No.: US 2021/0009083 A1
(43) Pub. Date: Jan. 14, 2021

(54) WIPER SYSTEM INCLUDING WIPER BLADES WITH DIFFERENT LENGTHS

(71) Applicants: HYUNDAI MOTOR COMPANY, Seoul (KR); KIA MOTORS CORPORATION, Seoul (KR)

(72) Inventors: Hun-Jae KIM, Hwaseong-si (KR); Joon-Woo LEE, Suwon-si (KR); Young-Jin LEE, Uiwang-si (KR)

(73) Assignees: HYUNDAI MOTOR COMPANY, Seoul (KR); KIA MOTORS CORPORATION, Seoul (KR)

(21) Appl. No.: 16/695,598

(22) Filed: Nov. 26, 2019

(30) Foreign Application Priority Data
Jul. 10, 2019 (KR) 10-2019-0083166

(51) Int. Cl. B60S 1/34; B60S 1/36

(52) U.S. Cl. CPC B60S 1/3425; B60S 1/36

(57) ABSTRACT

A wiper system including wiper blades with different lengths may include: an arm to be rotated, and a blade to be rotated with the arm. In particular, the arm includes a retainer to press the blade, and the blade includes: a primary coupled to a front end of the retainer; and a plurality of yokes coupled to the primary and to receive a transferred pressing force and to transfer the pressing force to a bertebra coupled to a lower side thereof.

### CROSS-REFERENCE TO RELATED APPLICATION

This application claims priority to and the benefit of Korean Patent Application No. 10-2019-0083166, filed on Jul. 10, 2019, the entire contents of which are incorporated herein by reference.

### FIELD

Exemplary embodiments of the present disclosure relate to a wiper system for removing rainwater and foreign substances on automotive glass of a vehicle.

### BACKGROUND

The statements in this section merely provide background information related to the present disclosure and may not constitute prior art.

FIG. 1 illustrates a wiper system of the present disclosure, and FIG. 2 is an exploded perspective view of FIG. 1.

With reference to FIGS. 1 and 2, a general wiper system will be described. The wiper system includes a motor (not illustrated), an arm 10 rotated by the motor, and a blade 20 rotated by the arm 10 to clean glass.

The arm 10 includes an arm head 11, an arm head cover 12, a spring 10, and a retainer 13, and the arm head 11 is engaged with a motor shaft to support the arm 10 and the blade 20 as a whole so that they are safely seated on a glass surface. The arm head cover 12 protects the arm head 11 to prevent physical damage and corrosion of an end portion of the motor shaft, and the spring 13 is a component connecting the arm head 11 and the retainer 14 to each other to adjust a pressing force of the retainer 14. Further, the retainer 14 transfers an elastic force of the spring 13 to a primary 21 of the blade 20 as the pressing force, and it is coupled to the arm head 11 and the primary 21 to form a rotating pin joint structure.

The blade 20 is composed of a primary 21, a bertebra 22, a rubber 23, a tip yoke 24, and a hill yoke 25. The primary 21 is a medium connecting structures of the arm 10 and the blade 20 to each other, and it serves as a body that holds respective components of the blade 20 so that the components are put in their own locations. The tip yoke 24 distributes a pressing force transferred from the primary 21 onto section A (blade front end region), and the hill yoke 25 distributes a pressing force transferred from the arm 10 onto section B (blade rear end region), resulting in that the pressing force is uniformly distributed onto the rubber 23 as a whole. Last, the rubber 23 directly cleans the glass surface of the vehicle.

However, we have discovered that during such a wiper cleaning operation, vibration occurs due to a linear velocity difference between the front end and the rear end of the blade 20.

In FIG. 3, “v” denotes a linear velocity, and “r” denotes a radius. Because a linear velocity v₂ of the front end of the blade 20 is higher than a linear velocity v₁ of the rear end of the blade, and the velocity and a friction coefficient are in a reverse proportion relationship, the coefficient of the rear end portion r₁ having a low velocity becomes higher than the coefficient of the front end portion r₂.

Accordingly, because the friction coefficient becomes higher and friction dispersion also becomes higher at the same time, the vibration (shaking) occurs.

We have also found that during vehicle cleaning, on the glass surface coated with wax or water repellent agent, such vibration is further amplified caused by the change of the friction coefficient between the blade rubber and the glass, and this may cause noise occurrence inside the vehicle and excessive chattering at the rear end portion of the blade.

The foregoing description of the background technology is intended merely to help the understanding of the background of the present disclosure, and is not intended to mean that the present disclosure falls within the purview of the related art that is already known to those of ordinary skill in the art.

### SUMMARY

Exemplary embodiments of the present disclosure provide a wiper system including wiper blades with different lengths, which can mitigate a chattering phenomenon caused by vibrations occurring when a wiper cleans glass through a structural change of the blades and can reduce noise through reduction of a chattering amount of rear end portions of the blades.

Other objects and advantages of the present disclosure can be understood by the following description, and become apparent with reference to the embodiments of the present disclosure. Also, it is obvious to those skilled in the art to which the present disclosure pertains that the objects and advantages of the present disclosure can be realized by the means as claimed and combinations thereof.

In one aspect of the present disclosure, a wiper system including wiper blades with different lengths includes: an arm configured to be rotated, and a blade configured to be rotated with the arm. In particular, the arm includes a retainer configured to press the blade, and the blade includes: a primary coupled to a front end of the retainer; and a plurality of yokes coupled to the primary and configured to receive a transferred pressing force and to transfer the pressing force to a bertebra coupled to a lower side thereof, and wherein yokes of the plurality of yokes have different lengths.

An overall length of the retainer may be in a range of approximately 150 mm to 160 mm.

A length between a front end of the primary and a coupling point with the retainer may be in a range of approximately 95 mm to 105 mm.

The yokes of the plurality of yokes may be configured to press two points of the bertebra, and a length between the two points at which a tip yoke among the yokes presses the bertebra may be in a range of approximately 105 mm to 125 mm.

The yokes of the plurality of yokes may be configured to press two points of the bertebra, and a length between the two points at which a hill yoke among the yokes presses the bertebra may be in a range of approximately 100 mm to 115 mm. In particular, the tip yoke is arranged in a front part of the primary, and the hill yoke is arranged in a rear part of the primary.

During the blade operation, the blade may make one rotation displacement with respect to a coupling point at which the primary is coupled to the retainer, and angles formed by the blade at a maximum rotation displacement in one rotation direction and the blade at a maximum rotation displacement in an opposite direction to the one rotation direction may be equal to each other regardless of the overall length of the retainer.

In one form, the angles formed by the blade at the maximum rotation displacement in the one rotation direction and the blade at the maximum rotation displacement in the opposite direction to the one rotation direction may be equal to the angles formed by the blade at the maximum rotation displacement in the one rotation direction and the blade at the maximum rotation displacement in the opposite direction to the one rotation direction in the case where the overall length of the retainer exceeds approximately 160 mm and equal to or smaller than approximately 180 mm.

In another aspect of the present disclosure, a wiper system including wiper blades with different lengths includes: an arm configured to be rotated, and a blade configured to be rotated with the arm, wherein the arm includes a retainer configured to press the blade, the blade includes a primary coupled to a front end of the retainer; a tip yoke coupled to a front end of the primary and configured to transfer a pressing force to a bertebra coupled to a lower side thereof; and a hill yoke coupled to a rear end of the primary and configured to transfer the pressing force to the bertebra coupled to the lower side thereof, and wherein a length between two points at which the tip yoke presses the bertebra is in a range of approximately 105 mm to 125 mm, and a length between two points at which the hill yoke presses the bertebra is in a range of approximately 100 mm to 115 mm.

An overall length of the retainer may be in a range of approximately 150 mm to 160 mm.

According to the wiper system including wiper blades with different lengths according to the present disclosure, by adjusting the length of the retainer and the length of the primary and by adjusting the coupling location of the retainer, the chattering phenomenon can be mitigated through strengthening of the load of the rear end portion that is the primary chattering occurrence portion, and noise can be reduced through reduction of the chattering amount at the rear end portion.

It is to be understood that both the foregoing general description and the following detailed description of the present disclosure are exemplary and explanatory and are intended to provide further explanation of the disclosure as claimed.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view illustrating a wiper system;

FIG. 2 is an exploded perspective view of FIG. 1;

FIG. 3 is a diagram illustrating a linear velocity difference between a front end portion and a rear end portion of a wiper system;

FIG. 4 is diagrams comparatively illustrating a wiper system in the related art and a wiper system according to an embodiment of the present disclosure;

FIG. 5 is a diagram illustrating the result of analysis by embodiment 2 of FIG. 4;

FIG. 6 is a diagram illustrating load distributions in accordance with a location of a blade according to the related art and an embodiment of the present disclosure;

FIG. 7 is diagrams comparatively illustrating operation states of a wiper system in the related art and a wiper system according to an embodiment of the present disclosure; and

FIGS. 8A and 8B are diagrams illustrating actual chattering amount measurement results according to the related art and an embodiment of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The above-described objects, features, and advantages of the present disclosure will be described in detail with reference to the accompanying drawings, and accordingly, those of ordinary skill in the art to which the present disclosure pertains will be able to fully understand and easily embody the technical concept of the present disclosure.

In describing exemplary embodiments of the present disclosure, detailed description of well-known technologies related to the present disclosure will be reduced or omitted in the case where it is determined that it obscures the subject matter of the present disclosure in unnecessary detail.

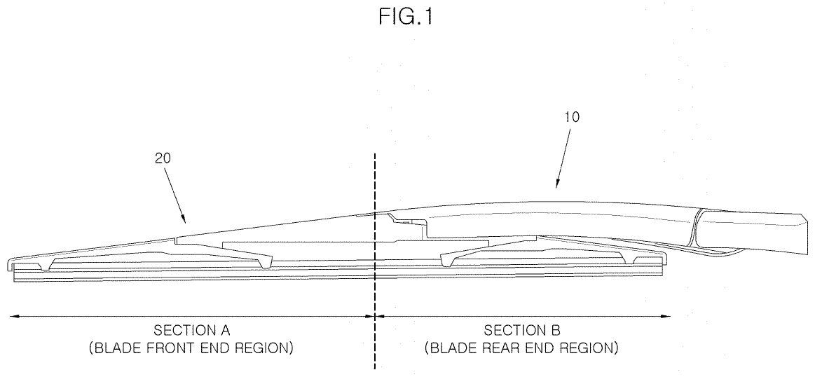

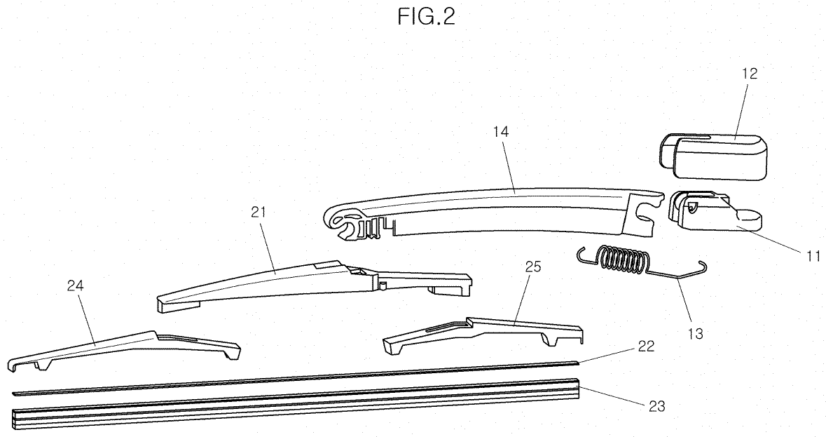

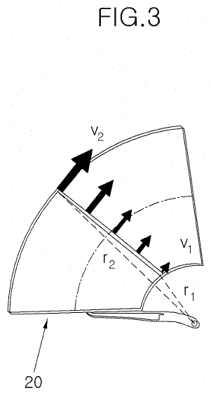

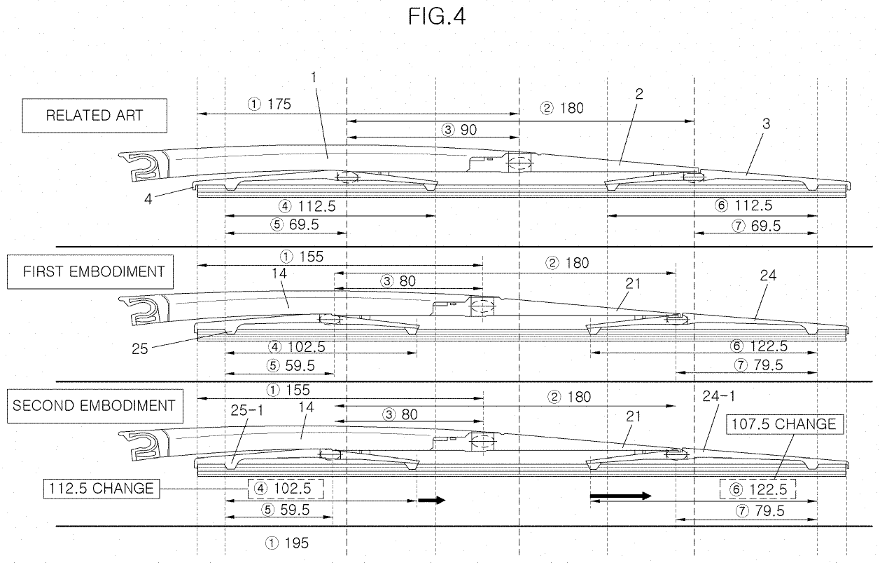

FIG. 1 is a view illustrating a wiper system, and FIG. 2 is an exploded perspective view of FIG. 1. FIG. 4 is a diagram comparatively illustrating a wiper system in the related art and a wiper system according to an embodiment of the present disclosure.

Hereinafter, with reference to FIGS. 1, 2, and 4, a wiper system including wiper blades with different lengths according to an embodiment of the present disclosure will be described.

In the wiper system, the linear velocity of a retainer located at a rear end is lower than the linear velocity of a retainer located at a front end among a plurality of retainers, and thus greater frictional force may occur at the rear end to cause greater chattering to occur at the rear end portion. Further, if the glass surface is coated, the chattering becomes severer.

According to the present disclosure, the chattering at the rear end portion can be substantially reduced or minimized through adjustment of locations and sizes of the retainers and primaries to further strengthen the load of the retainer located at the rear end among the plurality of retainers.

The wiper system according to one form of the present disclosure includes: a motor (not illustrated), an arm 10 rotated by the motor, and a blade 20 rotated by the arm 10 to clean glass.

In one form, the arm 10 may include an arm head 11, an arm head cover 12, a spring 13, and a retainer 14, and the arm head 11 is engaged with a motor shaft to support the arm 10 and the blade 20 as a whole so that they are safely seated on a glass surface. The arm head cover 12 protects the arm head 11 to prevent physical damage and corrosion of an end portion of the motor shaft, and the spring 13 is a component connecting the arm head 11 and the retainer 14 to each other to adjust a pressing force of the retainer 14. Further, the retainer 14 transfers an elastic force of the spring 13 to a primary 21 of the blade 20 as the pressing force, and it is coupled to the arm head 11 and the primary 21 to form a rotating pin joint structure.

In another form, the blade 20 includes: a primary 21, a bertebra 22, a rubber 23, a tip yoke 24, and a hill yoke 25. The primary 21 is a medium connecting structures of the arm 10 and the blade 20 to each other, and it serves as a body that holds respective components of the blade 20 so that the components are put in their own locations. As the tip yoke 24 is arranged in a front part of the primary 21, the tip yoke 24 distributes a pressing force transferred from the primary 21 onto section A (blade front end region), and the hill yoke 25 which is arranged in a rear part of the primary 21 may distribute a pressing force transferred from the arm 10 onto section B (blade rear end region), resulting in that the pressing force is uniformly distributed onto the rubber 23 as a whole. Last, the rubber 23 directly cleans the glass surface of the vehicle.

In the wiper system in the related art as described above, the lengths of the tip yoke 24 and the hill yoke 25 are set to be equal to each other.

In contrast, according to first and second embodiments of the present disclosure, the tip yokes 24 and 24-1 and the hill yokes 25 and 25-1 have different lengths to form a structure including wiper blades with different lengths.

For this, the overall length of the retainer 14 may be in the range of approximately 150 mm to 160 mm, and in an example of FIG. 4, it is exemplified that the overall length of the retainer 14 is approximately 155 mm. That is, as compared with the retainer 1 in the related art having the overall length of approximately 175 mm, the overall length of the retainer 14 according to the present disclosure is shorter than that of the retainer 1 in the related art for approximately 15 mm to 25 mm.

The length between the front end of the primary 21 and a coupling point with the retainer 14 is in a range of approximately 95 mm to 105 mm, and in an example of FIG. 4, it is exemplified that the corresponding length is approximately 100 mm. That is, if it is assumed that the length between the front end of the primary 2 and the coupling point with the retainer 1 in the related art is approximately 90 mm, the primary 21 according to the present disclosure is lengthened up to approximately 5 mm to 15 mm as compared with the primary 2 in the related art.

Accordingly, as compared with the related art, the embodiment of the present disclosure has the shortened retainer and the lengthened primary, and thus the coupling point between the tip yokes 24 and 24-1 and the primary 21 and the coupling point between the hill yokes 25 and 25-1 of the retainer 14 are moved toward the rear end as compared with the related art.

In one form, the length of the tip yokes 24 and 24-1 is in the range of approximately 105 mm to 125 mm in accordance with the length adjustment of the primary 21.

Here, the length of the tip yokes 24 and 24-1 means a length between two points at which the tip yokes 24 and 24-1 press the bertebra 22.

In the first embodiment, it is exemplified that the tip yoke 24 is approximately 122.5 mm, and in the second embodiment, it is exemplified that the tip yoke 24-1 is approximately 107.5 mm.

In another form, the length of the till yokes 25 and 25-1 may be in the range of approximately 100 mm to 115 mm. This is because the retainer 14 is shorter than that in the related art, and through such a length change, the pressing pressure thereon can be balanced with that on the front end portion.

Here, the length of the hill yokes 25 and 25-1 means a length between two points at which the hill yokes 25 and 25-1 press the bertebra 22.

It is exemplified that the hill yoke 25 according to the first embodiment is approximately 102.5 mm, and the hill yoke 25-1 according to the second embodiment is approximately 112.5 mm.

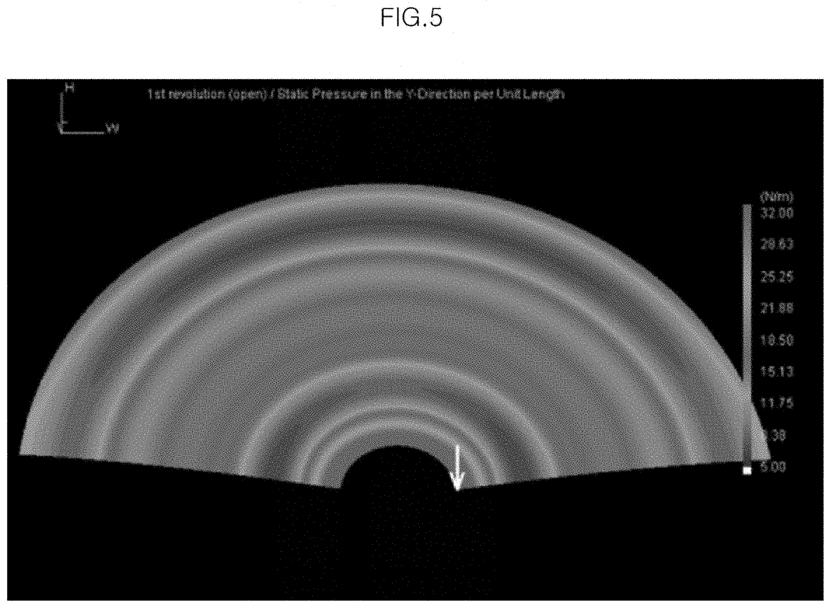

As the result of analysis of the second embodiment in accordance with the location change as described above, it can be known that the clean fertility in accordance with the chattering improvement as shown in FIG. 5 appears the technical level in the related art.

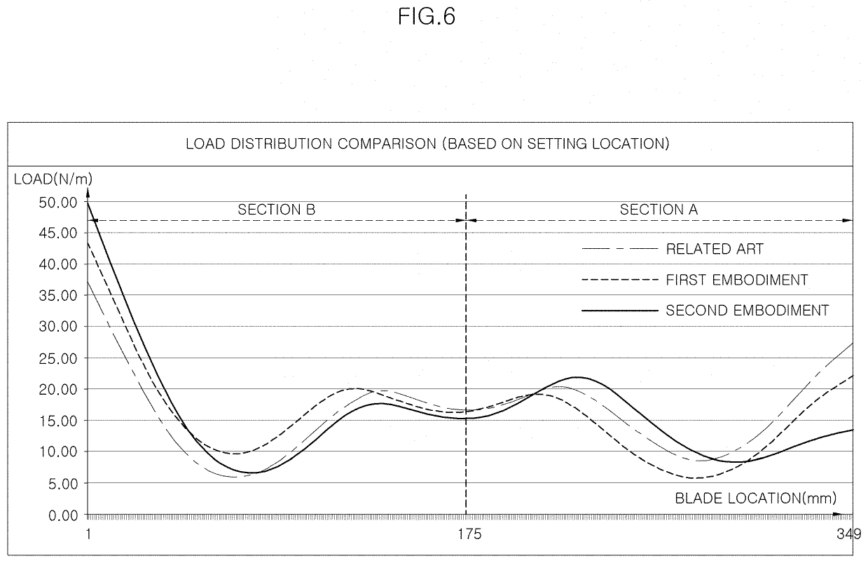

Further, as illustrated in FIG. 6, in accordance with the location from the front end to the rear end, it can be known that the load appears similar to that in the related art.

The configuration including wiper blades with different lengths according to the present disclosure shows no difference in clean fertility from that of the wiper system in the related art, but it can reduce noise because the rear end portion (section B) according to the present disclosure shows a difference in chattering amount.

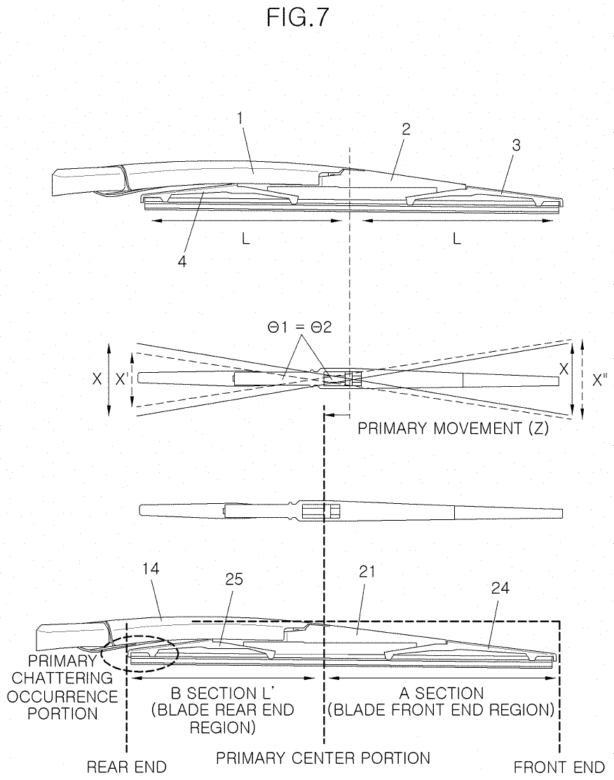

With reference to FIG. 7, in the related art, the length and the pressure distribution of section A (primary center portion to front end) are almost equal to those of section B (primary center portion to rear end) based on the center portion of the primary 2, whereas in the configuration including wiper blades with different lengths according to the present disclosure, the location of the primary 21 moves in the rear end direction to shorten the length of the section B, and thus the rotation amount of the rear end portion that is the primary chattering occurrence portion is reduced to mitigate the chattering phenomenon.

That is, because the assembly dimensions and tolerances between components according to the present disclosure are equal to those in the related art (θ1=θ2), the chattering phenomenon is mitigated, and the chattering amount is reduced. As described above, this is because the length of the retainer 14 is shortened, and the lengths and the pressure distributions of the section A and the section B become different from each other.

For reference, although the rotation amount of the front end portion is increased, the kinetic energy caused by the high linear velocity of the front end offsets the chattering caused by the vibration, and thus the chattering does not occur in the front end region.

This phenomenon can be recognized more clearly through comparison of operation states of wiper arm blades on a front passenger seat side and a driver seat side with each other in a front wiper system. That is, almost no chattering occurs at the front or rear end of the front passenger seat and at the front end portion of the driver seat due to occurrence of kinetic energy that offsets the vibrations, but the chattering occurs due to the low linear velocity at the rear end of the driver seat.

Next, a method for setting a movement amount of wiper blades with different lengths will be described.

It is assumed that L denotes a blade length of section B in the related art, X denotes a chattering amount at a rear end in the related art, L′ denotes a blade length of section B according to the present disclosure, X′ denotes a chattering amount at a rear end according to the present disclosure, Y denotes the overall length of a blade in the related art (=2L), and Z denotes a movement amount at a rear end of a center portion of a primary.

Because L:X=L′:X′ and L′=L−Z, L′*X=L*X′, and thus L′=LX′/X.

Because L′=L−Z, and thus Z=L−LX′/X, Z becomes as follow:

Z=L(1−X′/X), and Z=Y/2(1−X′/X)

Accordingly, an effective displacement becomes X′=X(1−2Z/Y).

In the case of the Z value, the optimum specification is determined based on the cleaning analysis, and the maximum value is set to a value whereby the wiper satisfies the cleaning load of 5 N/m or more in the overall section of the cleaning region based on the worst condition of the cleaning analysis.

As shown in FIG. 6, in the related art, the cleaning load is uniformly distributed on the overall section.

Although the load distribution is uniform, an intermittent chattering phenomenon occurs on a waxed surface.

According to the present disclosure, the primary is moved for a predetermined distance toward the rear end, and the pressing force (average load) on the section B (rear end to primary center portion) is increased.

If the pressing force is increased, the contact area between the rubber of the section B and the glass surface is relatively widened in comparison with that in the related art to increase the frictional force. In this case, the speed is lowered to cause a disadvantageous condition in the chattering phenomenon, but as illustrated in FIG. 7, the chattering phenomenon is mitigated through reduction of the rotation amount itself of the rear end of the blade.

In contrast, in the case of the section A, an average load (pressing force) is reduced, and thus the frictional force is reduced to cause the speed to be heightened. Although the rotation amount of the front end is increased as the primary moves toward the rear end, the kinetic energy caused by the high linear velocity of the front end offsets the chattering caused by the vibrations, and thus the chattering does not occur in the front end region.

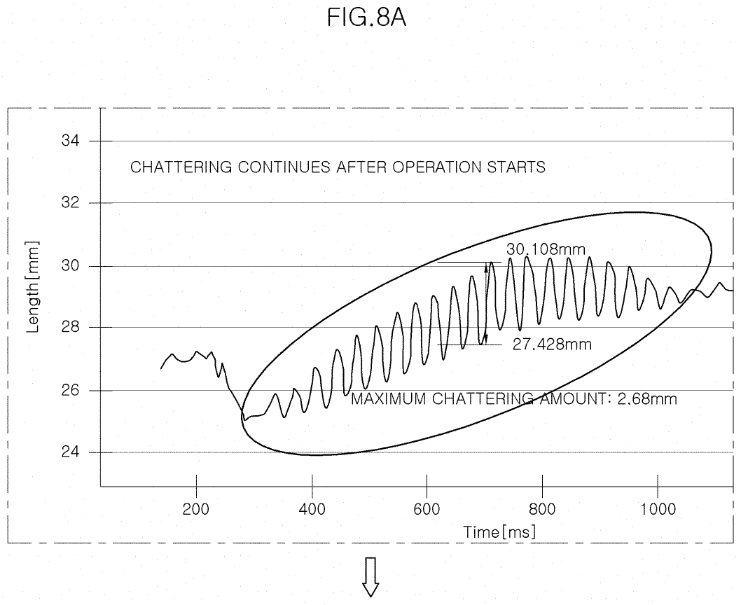

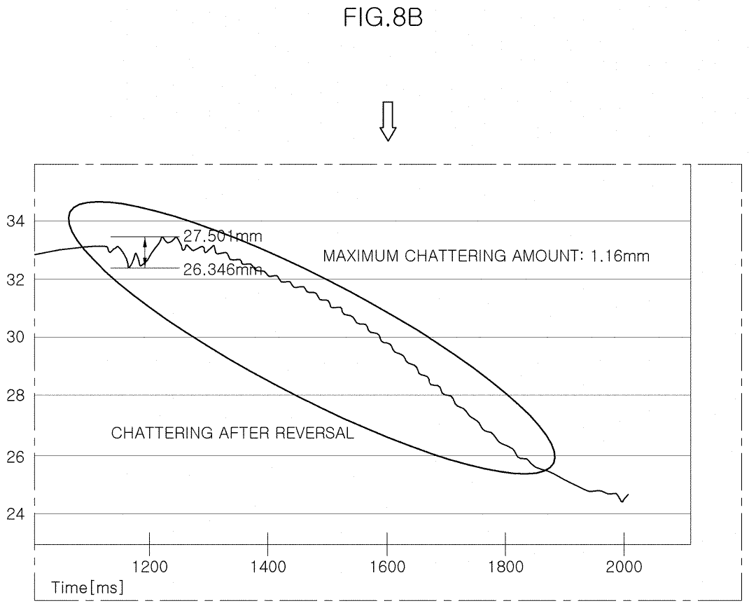

In order to confirm the principle in which the chattering amount is reduced by the wiper blades with different lengths, an experiment has been carried out with respect to a general cleaned glass and a wax polluted glass, and the result of the experiment is summarized in Table 1 below. FIGS. 8A and 8B are graphs showing reduced chattering amount.

TABLE 1

| | Maximum Chattering Amount (mm) | | | | | |
|---|---|---|---|---|---|---|
| | General Cleaned Glass | | | Wax Polluted Glass | | |
| | Maximum Chattering | | | Maximum Chattering | | |
| | Section Inflection | | Chattering | Section Inflection | | Chattering |
| | Point (Y axis) | | Amount | Point (Y axis) | | Amount |
| Related Art | 27.088 | 25.683 | 1.64 | 30.108 | 27.428 | 2.68 |
| 1^{st} Embodiment | 18.063 | 16.76 | 1.30 | 27.501 | 26.346 | 1.16 |
| 2^{nd} Embodiment | 26.306 | 24.916 | 1.39 | 26.229 | 24.682 | 1.55 |

With reference to Table 1 and the drawings, in comparison with the related art, it can be known that the chattering amount has been reduced in the case of the structure of wiper blades with different lengths, in which the retainer has moved toward the rear end for 15 mm to 25 mm, according to the present disclosure.

Based on the cleaning of the wax polluted glass, it can be known that the chattering amount has been maximally reduced from approximately 2.68 mm to 1.16 mm for approximately 1.5 mm change, that is, the chattering amount has been improved by 157%. In particular, the structure according to the present disclosure can be more effective on the wax coated glass on which the blade is greatly chattered and noisy.

In addition, the present disclosure can contribute to the improvement of the overall durability, such as the blade rubber and structures, and the load on the motor, even in the case of the uniform cleaning performance and the same direction, and it can contribute to the reduction of the weight of the wiper system through reduction of the retainer length.

While the present disclosure has been described with reference to the exemplified drawings, it will be apparent to those of ordinary skill in the art that the present disclosure is not limited to the described embodiments, and various changes and modifications may be made without departing from the spirit and scope of the present disclosure. Accordingly, such changes and modifications should belong to the claims of the present disclosure, and the right of the present disclosure should be construed based on the appended claims.

What is claimed is:

1. A wiper system including wiper blades with different lengths, the wiper system comprising:
an arm configured to be rotated; and
a blade configured to be rotated with the arm,
wherein the arm includes a retainer configured to press the blade, and
the blade includes:
a primary coupled to a front end of the retainer; and
a plurality of yokes coupled to the primary and configured to receive a transferred pressing force and to transfer the pressing force to a bertebra coupled to a lower side thereof, and
wherein yokes of the plurality of yokes have different lengths.

2. The wiper system according to claim 1, wherein an overall length of the retainer is in a range of approximately 150 mm to 160 mm.

3. The wiper system according to claim 2, wherein a length between a front end of the primary and a coupling point with the retainer is in a range of approximately 95 mm to 105 mm.

4. The wiper system according to claim 3, wherein:
the yokes of the plurality of yokes are configured to press two points of the bertebra,
a length between the two points at which a tip yoke among the yokes presses the bertebra is in a range of approximately 105 mm to 125 mm, and
the tip yoke is arranged in a front part of the primary.

5. The wiper system according to claim 3, wherein:
the yokes of the plurality of yokes are configured to press two points of the bertebra,
a length between the two points at which a hill yoke among the yokes presses the bertebra is in a range of approximately 100 mm to 115 mm, and
the hill yoke is arranged in a rear part of the primary.

6. The wiper system according to claim 2, wherein when the blade operates, the blade makes one rotation displacement with respect to a coupling point at which the primary is coupled to the retainer, and
angles formed by the blade at a maximum rotation displacement in one rotation direction and the blade at a maximum rotation displacement in an opposite direction to the one rotation direction are equal to each other regardless of the overall length of the retainer.

7. The wiper system according to claim 6, wherein the angles formed by the blade at the maximum rotation displacement in the one rotation direction and the blade at the maximum rotation displacement in the opposite direction to the one rotation direction are equal to the angles formed by the blade at the maximum rotation displacement in the one rotation direction and the blade at the maximum rotation displacement in the opposite direction to the one rotation direction where the overall length of the retainer exceeds approximately 160 mm and equal to or less than approximately 180 mm.

8. A wiper system including wiper blades with different lengths, the wiper system comprising:
an arm configured to be rotated; and
a blade configured to be rotated with the arm,
wherein the arm includes a retainer configured to press the blade, and
the blade includes:
a primary coupled to a front end of the retainer;
a tip yoke coupled to a front end of the primary and configured to transfer a pressing force to a bertebra coupled to a lower side thereof; and
a hill yoke coupled to a rear end of the primary and configured to transfer the pressing force to the bertebra coupled to the lower side thereof, and
wherein a length between two points at which the tip yoke presses the bertebra is in a range of approximately 105 mm to 125 mm, and a length between two points at which the hill yoke presses the bertebra is in a range of approximately 100 mm to 115 mm.

9. The wiper system according to claim 8, wherein an overall length of the retainer is in a range of approximately 150 mm to 160 mm.
